(19) United States
(12) Patent Application Publication
(10) Pub. No.: US 2015/0134959 A1
(43) Pub. Date: May 14, 2015

(54) Instant Communication Method and System

(71) Applicants: Kwok fong Wong, Heshan (CN); Pui yi Ching, Heshan (CN)

(72) Inventors: Kwok fong Wong, Heshan (CN); Pui yi Ching, Heshan (CN)

(73) Assignee: WWTT Technology China, Heshan, Guangdong (CN)

(21) Appl. No.: 14/000,210

(22) PCT Filed: Jan. 25, 2013
(86) PCT No.: PCT/CN13/71003

§ 371 Date: Aug. 17, 2013

(30) Foreign Application Priority Data
Oct. 24, 2012 (CN) 201210408510.3

(51) Int. Cl. H04L 29/06

(52) U.S. Cl. CPC H04L 63/0861; H04L 63/0435; H04L 63/061
USPC 713/171; 713/168

(57) ABSTRACT

An instant communication method comprises: (a) obtaining the fingerprint information of an instant communication receiving terminal, and performing identity authentication on the instant communication receiving terminal utilizing the fingerprint information at an instant communication transmitting terminal; (b) generating and encrypting audio and video information to obtain encrypted information at the instant communication transmitting terminal, after successful authentication of the instant communication receiving terminal; and (c) transmitting the encrypted information from the instant communication transmitting terminal to the receiving terminal, and receiving and decrypting the encrypted audio and video information at the receiving terminal to obtain and display the audio and video information. An instant communication system comprises an instant communication transmitting terminal. Therefore, the privacy of instant messages such as audio, video and the like can be ensured powerfully, and the communication security is greatly improved with the present invention.

### FIELD OF THE INVENTION

The invention relates to communication technology field, more particularly to an instant communication method and system.

### BACKGROUND OF THE INVENTION

With the rapid development of communication technology, functionalities of instant communication software are continuously strengthened. Generally people can chat with each other not only by sending instant messages such as characters, images or emotions via instant communication software, but also by sending instant messages such as audio, video via instant communication software.

However, currently, when one chats with another one through instant messages such as audio or video, the instant messages such as audio or video are directly transmitted from one to another one, and the instant messages such as audio or video will be displayed directly after another one receiving it.

Accordingly, there are at least following disadvantages in the prior art:

In the method of prior art, the instant messages such as audio or video are transmitted and displayed directly, thus, the instant messages are accessible to any third part, which can not be protected effectively and have poor security.

### SUMMARY OF THE INVENTION

In order to overcome the above problems existing in prior art, the invention provides an instant communication method and system, and the following technical solution is disclosed:

According to one aspect of the invention, an instant communication method is provided, which comprises the steps of:

(a) obtaining the fingerprint information of an instant communication receiving terminal, and performing identity authentication on the instant communication receiving terminal utilizing the fingerprint information at an instant communication transmitting terminal;

(b) generating and encrypting audio and video information to obtain encrypted audio and video information at the instant communication transmitting terminal, after successful authentication of the instant communication receiving terminal; and

(c) transmitting the encrypted audio and video information from the instant communication transmitting terminal to the instant communication receiving terminal, and receiving and decrypting the encrypted audio and video information at the instant communication receiving terminal to obtain and display the audio and video information.

According to another aspect of the invention, an instant communication system comprising an instant communication transmitting terminal is provided, wherein the instant communication transmitting terminal comprises:

a transmitting terminal fingerprint sensor, which is used for obtaining the fingerprint information of the instant communication receiving terminal and performing identity authentication on the instant communication receiving terminal using the fingerprint information of the instant communication receiving terminal;

an audio and video information generator electrically coupled to the transmitting terminal fingerprint sensor, which is used for generating audio and video information after the transmitting terminal fingerprint sensor accomplishing successful authentication of the instant communication receiving terminal;

a transmitting terminal real-time monitoring processor electrically coupled to the audio and video information generator, which is used for encrypting the audio and video information to obtain encrypted audio and video information after the audio and video information being generated by the audio and video information generator; and

an audio and video information transmitter electrically coupled to the transmitting terminal real-time monitoring processor, which is used for transmitting the encrypted audio and video information obtained by the transmitting terminal real-time monitoring processor to the instant communication receiving terminal, such that the instant communication receiving terminal receives and decrypts the encrypted audio and video information to obtain and display the audio and video information.

As compared with the prior art, the invention has following advantages: in the invention, identity authentication is performed on the instant communication receiving terminal by obtaining and using the fingerprint information of the instant communication receiving terminal, and the audio and video information is transmitted to the instant communication receiving terminal after being encrypted, such that the audio and video information is obtainable by only the instant communication receiving terminal after successful authentication, thus, instant messages such as audio and video are not accessible to any third party, furthermore, the obtained audio and video information is encrypted, thus, the privacy of the instant messages such as audio and video can be ensured and security is improved greatly.

### BRIEF DESCRIPTION OF DRAWINGS

In order to illustrate more clearly the technical solutions of the invention, the drawings used in preferred embodiments of the present invention will now be described simply, so that the advantages and features of the invention can be easily understood by a person skilled in the art, however, it is obvious, for a person skilled in the art, that the drawing described hereinafter are only some of embodiments, and many equivalent drawings can be obtained without departing from the protecting scope of the invention.

FIG. 1 is a flow chart showing an instant communication method according to embodiment 1 of the invention.

FIG. 2 is a flow chart showing an instant communication method according to embodiment 2 of the invention.

FIG. 3 is a block diagram showing an instant communication system according to embodiment 3 of the invention.

FIG. 4 is a block diagram showing another instant communication system according to embodiment 3 of the invention.

FIG. 5 is a block diagram showing still another instant communication system according to embodiment 3 of the invention.

### DETAILED DESCRIPTION OF THE INVENTION

is In order to illustrate more clearly the objects, technical solutions and advantages of the invention, the preferred embodiments of the invention will be described in more detail hereinafter with reference to accompanying drawings.

### Embodiment 1

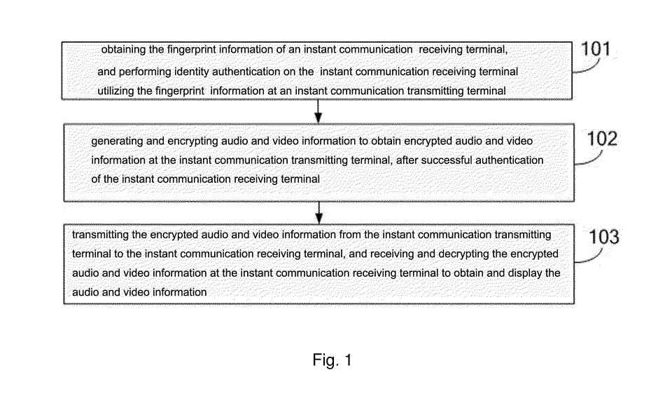

Referring to FIG. 1 showing embodiment 1 of the invention, an instant communication method is provided in this embodiment, which comprises the steps of:

101: obtaining the fingerprint information of an instant communication receiving terminal, and performing identity authentication on the instant communication receiving terminal utilizing the fingerprint information at an instant communication transmitting terminal;

102: generating and encrypting audio and video information to obtain encrypted audio and video information at the instant communication transmitting terminal, after successful authentication of the instant communication receiving terminal; and

103: transmitting the encrypted audio and video information from the instant communication transmitting terminal to the instant communication receiving terminal, and receiving and decrypting the encrypted audio and video information at the instant communication receiving terminal to obtain and display the audio and video information.

Preferably, before the step of obtaining the fingerprint information of the instant communication receiving terminal at the instant communication transmitting terminal the method further comprises the steps of:

(a₁) transmitting a key exchange request and the fingerprint information of the instant communication transmitting terminal from the instant communication transmitting terminal to the instant communication receiving terminal; and

(a₂) receiving the key exchange confirmation information and the fingerprint information of the instant communication receiving terminal from the instant communication receiving terminal at the instant communication transmitting terminal.

More preferably, wherein the step of generating and encrypting audio and video information to obtain encrypted audio and video information at the instant communication transmitting terminal comprises:

(b₁) starting a audio and video application after obtaining an enabled instruction, to perform audio and video operation and generate the audio and video information at the instant communication transmitting terminal; and

(b₂) encrypting the audio and video information by using the fingerprint information of the instant communication transmitting terminal to obtain the encrypted audio and video information at the instant communication transmitting terminal.

Still another preferably, the step (b₂) further comprises the steps of:

(b₂₁) encrypting the whole audio and video information generated at the instant communication transmitting terminal using the fingerprint information of the instant communication transmitting terminal to obtain fully encrypted audio and video information at the instant communication transmitting terminal; or

(b₂₂) encrypting a part of the audio and video information generated at the instant communication transmitting terminal using the fingerprint information of the instant communication transmitting terminal to obtain partially encrypted audio and video information at the instant communication transmitting terminal.

Preferably, before the step of receiving and decrypting the encrypted audio and video information at the instant communication receiving terminal the method also comprises the steps of:

(c₁) obtaining the fingerprint information of the instant communication transmitting terminal, and performing identity authentication on the instant communication transmitting terminal using the fingerprint information of the instant communication transmitting terminal at the instant communication receiving terminal; and

(c₂) starting the step of receiving and decrypting the audio and video encrypted information at the instant communication receiving terminal, after successful authentication of the instant communication transmitting terminal.

In the instant communication method of this embodiment of the invention, identity authentication is performed on the instant communication receiving terminal by obtaining and utilizing the fingerprint information of the instant communication receiving terminal, and the audio and video information is transmitted to the instant communication receiving terminal after being encrypted, such that the audio and video information can be obtained only by the instant communication receiving terminal after successful authentication, thus, the instant messages such as audio, video and the like are not accessible to any third party, and the privacy and security of which can be ensured powerfully.

Moreover, it should be appreciated that the instant communication method of this embodiment of the invention can be used in various instant communication software's, such as micro-blog, QQ, MSN, Skype, micro-message and the like. Additionally, the instant communication method of the invention is applicable to not only one-to-one chat but also group chat, in group chat, a user without the key of instant communication transmitting terminal can see only the unencrypted parts of the audio and video information transmitted by the instant communication transmitting terminal, that is to say, the encrypted parts of the audio and video information can not be seen by this user.

### Embodiment 2

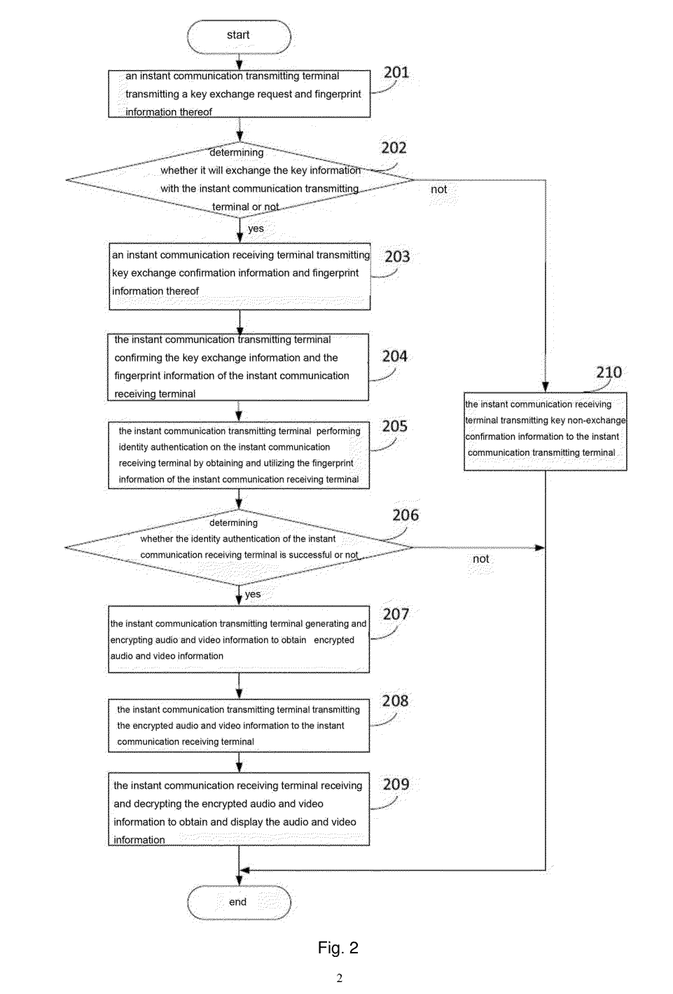

Referring to FIG. 2 showing embodiment 2 of the invention, an instant communication method is provided in this embodiment, which comprises the steps of:

201: transmitting a key exchange request and the fingerprint information of the instant communication transmitting terminal from the instant communication transmitting terminal to the instant communication receiving terminal.

Preferably, when the instant communication transmitting terminal desires to transmit encrypted audio and video information to the instant communication receiving terminal, the instant communication transmitting terminal may send a key exchange request and fingerprint information thereof to the instant communication receiving terminal

Preferably, the fingerprint information of this embodiment is a key.

More preferably, a transmitting terminal fingerprint sensor is provided at the instant communication transmitting terminal, which is configured to extract the fingerprint information of a user corresponding to the instant communication transmitting terminal, to obtain the fingerprint information of the instant communication transmitting terminal. Furthermore, the fingerprint information of the user at the instant communication transmitting terminal can be stored in a memory of the instant communication transmitting terminal or in a memory of a server.

202: the instant communication receiving terminal receiving the key exchange request and the fingerprint information of the instant communication transmitting terminal and determining whether it will exchanges the key information with the instant communication transmitting terminal or not. If yes, then the step of 203 will be performed, otherwise the step of 210 will be performed.

Preferably, the instant communication receiving terminal can store the fingerprint information of the instant communication transmitting terminal in the memory of the instant communication receiving terminal or in the memory of the server. When it is necessary to perform identity authentication on the instant communication transmitting terminal, the desired information will be read out from the memory to perform authentication.

203: transmitting key exchange confirmation information and the fingerprint information of the instant communication receiving terminal from the instant communication receiving terminal to the instant communication transmitting terminal.

Preferably, a fingerprint sensor is provided at the instant communication receiving terminal, which is configured to extract the fingerprint information of a user at the instant communication receiving terminal. Furthermore, the fingerprint information can be stored in a memory of the instant communication receiving terminal or in the memory of the server.

204: receiving the key exchange confirmation information and the fingerprint information of the instant communication receiving terminal from the instant communication receiving terminal at the instant communication transmitting terminal.

Preferably, the instant communication transmitting terminal can store the fingerprint information of the instant communication receiving terminal in the memory of the instant communication transmitting terminal or in the memory of the server. When it is necessary to perform identity authentication on the instant communication receiving terminal, the desired information will be read out from the memory to perform authentication.

205: transmitting an audio and video communication request from the instant communication receiving terminal to the instant communication transmitting terminal, and obtaining the fingerprint information of the instant communication receiving terminal and performing identity authentication on the instant communication receiving terminal by utilizing the fingerprint information of the instant communication receiving terminal at the instant communication transmitting terminal.

Preferably, the instant communication transmitting terminal searches the stored fingerprint information to determine whether the fingerprint information corresponding to the instant communication receiving terminal can be found out or not, if yes, then the identity of the instant communication receiving terminal is legal, that is to say, the successful authentication is achieved for the instant communication receiving terminal.

206: determining whether the identity authentication of the instant communication receiving terminal is successful or not at the instant communication transmitting terminal. If yes, then the step of 207 will be performed, otherwise the procedure is ended.

207: generating and encrypting audio and video information to obtain encrypted audio and video information at the instant communication transmitting terminal.

Wherein the audio and video information includes sound recording, video or the like. In a specific embodiment, it is possible that the whole audio and video information is encrypted, or alternatively only a part of audio and video information chose by the user is encrypted. A user can choose the encryption way for audio and video information according to the practical application, this is not limited herein.

Preferably, the step of (207) generating and encrypting audio and video information to obtain encrypted audio and video information at the instant communication transmitting terminal comprises the steps of:

starting an audio and video application after obtaining an enabled instruction, to perform audio and video operation and generate the audio and video information at the instant communication transmitting terminal; and

encrypting the audio and video information using the fingerprint information of the instant communication transmitting terminal to obtain the encrypted audio and video information at the instant communication transmitting terminal.

Wherein the step of encrypting the audio and video information using the fingerprint information of the instant communication transmitting terminal to obtain the encrypted audio and video information at the instant communication transmitting terminal comprises:

encrypting the whole audio and video information generated at the instant communication transmitting terminal using the fingerprint information of the instant communication transmitting terminal to obtain fully encrypted audio and video information at the instant communication transmitting terminal; or

encrypting a part of the audio and video information generated at the instant communication transmitting terminal using the fingerprint information of the instant communication transmitting terminal to obtain partially encrypted audio and video information at the instant communication transmitting terminal.

208: transmitting the encrypted audio and video information from the instant communication transmitting terminal to the instant communication receiving terminal.

209: receiving and decrypting the encrypted audio and video information to obtain and display the audio and video information at the instant communication receiving terminal. Then the procedure is ended.

Preferably, before the step of receiving and decrypting the encrypted audio and video information at the instant communication receiving terminal, the method also comprises: obtaining the fingerprint information of the instant communication transmitting terminal, and performing identity authentication on the instant communication transmitting terminal using the fingerprint information of the instant communication transmitting terminal at the instant communication receiving terminal; and

starting the step of receiving and decrypting the audio and video encrypted information at the instant communication receiving terminal, after successful authentication of the instant communication transmitting terminal.

210: transmitting key non-exchange confirmation information from the instant communication receiving terminal to the instant communication transmitting terminal. Then the procedure is over.

In the instant communication method of this embodiment of the invention, identity authentication is performed on the instant communication receiving terminal by obtaining and utilizing the fingerprint information of the instant communication receiving terminal, and the audio and video information is transmitted to the instant communication receiving terminal after being encrypted, such that the audio and video information can be obtained only by the instant communication receiving terminal after successful authentication, thus, the instant messages such as audio, video and the like are not accessible to any third party, and the privacy and security of which can be ensured powerfully.

### Embodiment 3

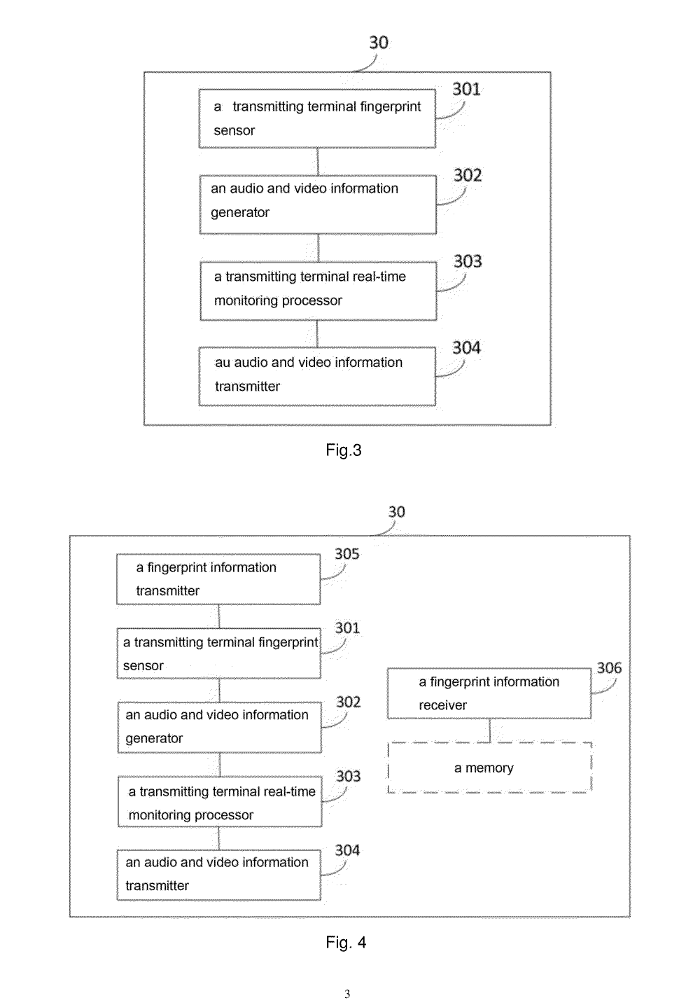

Referring to FIG. 3 showing embodiment 3 of the invention, an instant communication system comprising an instant communication transmitting terminal 30 is provided in this embodiment, which comprises:

a transmitting terminal fingerprint sensor 301, which is used for obtaining the fingerprint information of the instant communication receiving terminal 40 and performing identity authentication on the instant communication receiving terminal 40 using the fingerprint information of the instant communication receiving terminal 40;

an audio and video information generator 302 electrically coupled to the transmitting terminal fingerprint sensor 301, which is used for generating audio and video information after the transmitting terminal fingerprint sensor 301 accomplishing successful authentication of the instant communication receiving terminal 40;

a transmitting terminal real-time monitoring processor 303 electrically coupled to the audio and video information generator 302, which is used for encrypting the audio and video information to obtain encrypted audio and video information after the audio and video information being generated by the audio and video information generator 302; and

an audio and video information transmitter 304 electrically coupled to the transmitting terminal real-time monitoring processor 303, which is used for transmitting the encrypted audio and video information obtained by the transmitting terminal real-time monitoring processor 303 to the instant communication receiving terminal 40, such that the instant communication receiving terminal 40 receives and decrypts the encrypted audio and video information to obtain and display the audio and video information.

Preferably, the transmitting terminal fingerprint sensor 301 is also used for extracting the fingerprint information of a user corresponding to the instant communication transmitting terminal 30 to obtain the fingerprint information of the instant communication transmitting terminal 30.

Correspondingly, referring to FIG. 4, the instant communication transmitting terminal 30 further comprises:

a fingerprint information transmitter 305 electrically coupled to the transmitting terminal fingerprint sensor 301, which is used for sending a key exchange request and the fingerprint information of the instant communication transmitting terminal 30 extracted by the transmitting terminal fingerprint sensor 301 to the instant communication receiving terminal 40; and

a fingerprint information receiver 306 electrically coupled to a memory of the instant communication transmitting terminal 30 or to a memory of a server, which is used for receiving the key exchange confirmation information and the fingerprint information of the instant communication receiving terminal 40 from the instant communication receiving terminal 40, and for storing the fingerprint information of the instant communication receiving terminal 40 in the memory of the instant communication transmitting terminal or in the memory of the server.

For example, wherein the server is one or more computers for providing communication service between the instant communication transmitting terminal 30 and the instant communication receiving terminal 40.

Preferably, the audio and video information generator 302 is specifically used for obtaining an enabled instruction for starting an audio and video application, to perform audio and video operation and generate the audio and video information.

Preferably, the transmitting terminal real-time monitoring processor 303 is specifically used for encrypting the audio and video information using the fingerprint information of the instant communication transmitting terminal 30 to obtain the encrypted audio and video information.

More preferably, the transmitting terminal real-time monitoring processor 303 further comprises:

a first real-time monitoring sub-processor electrically coupled to the audio and video information generator 302, which is used for encrypting the whole audio and video information generated by the instant communication transmitting terminal 30 by utilizing the fingerprint information of the instant communication transmitting terminal 30, to obtain the fully encrypted audio and video information of the instant communication transmitting terminal 30; or

a second real-time monitoring sub-processor electrically coupled to the audio and video information generator 302, which is used for encrypting a part of the audio and video information generated by the instant communication transmitting terminal 30 by utilizing the fingerprint information of the instant communication transmitting terminal 30, to obtain the partially encrypted audio and video information of the instant communication transmitting terminal 30.

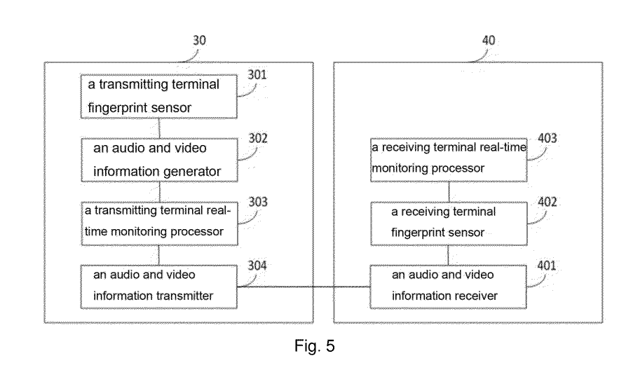

Preferably, referring to FIG. 5, the system also comprises an instant communication receiving terminal 40 which comprises:

an audio and video information receiver 401 electrically coupled to the audio and video information transmitter 304, which is used for receiving the encrypted audio and video information from the audio and video information transmitter 304;

a receiving terminal fingerprint sensor 402 electrically coupled to the audio and video information receiver 401, which is used for obtaining the fingerprint information of the instant communication transmitting terminal 30 and performing identity authentication on the instant communication transmitting terminal 30 by utilizing the fingerprint information of the instant communication transmitting terminal 30, after the audio and video information receiver 401 receiving the encrypted audio and video information from the audio and video information transmitter 304; and

a receiving terminal real-time monitoring processor 403 electrically coupled to the receiving terminal fingerprint sensor 402, which is used for decrypting the encrypted audio and video information to obtain and display the audio and video information, after the receiving terminal fingerprint sensor 402 accomplishing successful authentication of the instant communication transmitting terminal 30.

It should be noted, that various devices of the embodiments of the invention can connected to each other by wired, wireless or other ways, this is not limited herein, a user can configure the devices according to the practical application.

In the instant communication method of this embodiment of the invention, identity authentication is performed on the instant communication receiving terminal by obtaining and utilizing the fingerprint information of the instant communication receiving terminal, and the audio and video information is transmitted to the instant communication receiving terminal after being encrypted, such that the audio and video information can be obtained only by the instant communication receiving terminal after successful authentication, thus, the instant messages such as audio, video and the like are not accessible to any third party, and the privacy and security of which can be ensured powerfully.

It is noted that, the instant communication system provided in the above embodiment is illustrated by dividing the above function modules, in practical application, the functionalities can be designated to different function modules, that is to say, and the inner structure of the system is divided into different functional modules to achieve the partial or full functionalities described hereinbefore. Furthermore, the instant communication system provided in the above embodiments belong to the same technical concept as the instant communication method of the invention, and thus the implementation of the system can be seen in the method embodiments, it is not described in more detail herein.

The numberings of above embodiments are given for the purpose of illustration, and thus which don't represent the quality of the embodiments.

It shall be appreciated, for a person skilled in the art, that all or parts of the steps of above embodiments can be achieved by hardware, or achieved by program instructing the relevant hardware, the program can stored in a computer readable storage medium which can be a ROM, disc or disk or the like.

The above preferred embodiments of the invention are described by way of example, and shall not be considered as limitation of the invention. Any modifications, equivalent replacements or improvements within the spirit scope of the invention shall be covered in the extent of protection of the invention.

What is claimed is:

1. A method of the instant communication, comprising the following steps:
(a) obtaining the fingerprint information of an instant communication receiving terminal, and performing identity authentication on the instant communication receiving terminal utilizing the fingerprint information at an instant communication transmitting terminal;
(b) generating and encrypting audio and video information to obtain encrypted audio and video information at the instant communication transmitting terminal, after successful authentication of the instant communication receiving terminal; and
(c) transmitting the encrypted audio and video information from the instant communication transmitting terminal to the instant communication receiving terminal, and receiving and decrypting the encrypted audio and video information at the instant communication receiving terminal to obtain and display the audio and video information.

2. The method according to claim 1, wherein before the step of obtaining the fingerprint information of the instant communication receiving terminal at the instant communication transmitting terminal the method further comprises the steps of:
(a₁) transmitting a key exchange request and the fingerprint information of the instant communication transmitting terminal from the instant communication transmitting terminal to the instant communication receiving terminal; and
(a₂) receiving the key exchange confirmation information and the fingerprint information of the instant communication receiving terminal from the instant communication receiving terminal at the instant communication transmitting terminal.

3. The method according to claim 1, wherein the step of generating and encrypting audio and video information to obtain encrypted audio and video information at the instant communication transmitting terminal comprises:
(b₁) starting a audio and video application after obtaining an enabled instruction, performing audio and video operation and generating the audio and video information at the instant communication transmitting terminal; and
(b₂) encrypting the audio and video information using the fingerprint information of the instant communication transmitting terminal to obtain the encrypted audio and video information at the instant communication transmitting terminal.

4. The method according to claim 3, wherein the step (b₂) further comprises the steps of:
(b₂₁) encrypting the whole audio and video information generated at the instant communication transmitting terminal using the fingerprint information of the instant communication transmitting terminal to obtain fully encrypted audio and video information at the instant communication transmitting terminal; or
(b₂₂) encrypting a part of the audio and video information generated at the instant communication transmitting terminal using the fingerprint information of the instant communication transmitting terminal to obtain partially encrypted audio and video information at the instant communication transmitting terminal.

5. The method according to any one of claims 1-4, wherein before the step of receiving and decrypting the encrypted audio and video information at the instant communication receiving terminal the method also comprises the steps of:
(c₁) obtaining the fingerprint information of the instant communication transmitting terminal, and performing identity authentication on the instant communication transmitting terminal using the fingerprint information of the instant communication transmitting terminal at the instant communication receiving terminal; and
(c₂) starting the step of receiving and decrypting the audio and video encrypted information at the instant communication receiving terminal, after successful authentication of the instant communication transmitting terminal.

6. A system for the instant communication comprising an instant communication transmitting terminal, wherein the instant communication transmitting terminal comprises:
a transmitting terminal fingerprint sensor, which is used for obtaining the fingerprint information of the instant communication receiving terminal and performing identity authentication on the instant communication receiving terminal using the fingerprint information of the instant communication receiving terminal;
an audio and video information generator electrically coupled to the transmitting terminal fingerprint sensor, which is used for generating audio and video information after the transmitting terminal fingerprint sensor accomplishing successful authentication of the instant communication receiving terminal;
a transmitting terminal real-time monitoring processor electrically coupled to the audio and video information generator, which is used for encrypting the audio and video information to obtain encrypted audio and video information after the audio and video information being generated by the audio and video information generator; and
an audio and video information transmitter electrically coupled to the transmitting terminal real-time monitoring processor, which is used for transmitting the encrypted audio and video information obtained by the transmitting terminal real-time monitoring processor to the instant communication receiving terminal, such that the instant communication receiving terminal receives and decrypts the encrypted audio and video information to obtain and display the audio and video information.

7. The system according to claim 6, wherein the transmitting terminal fingerprint sensor is also used for extracting the fingerprint information of a user corresponding to the instant communication transmitting terminal to obtain the fingerprint information of the instant communication transmitting terminal,
correspondingly the instant communication transmitting terminal further comprising:
a fingerprint information transmitter electrically coupled to the transmitting terminal fingerprint sensor, which is used for sending a key exchange request and the fingerprint information of the instant communication transmitting terminal extracted by the transmitting terminal fingerprint sensor to the instant communication receiving terminal; and
a fingerprint information receiver electrically coupled to a memory of the instant communication transmitting terminal or to a memory of a server, which is used for receiving a key exchange confirmation information and the fingerprint information of the instant communication receiving terminal from the instant communication receiving terminal, and for storing the fingerprint information of the instant communication receiving terminal in the memory of the instant communication transmitting terminal or in the memory of the server.

8. The system according to claim 6, wherein the audio and video information generator is specifically used for obtaining an enabled instruction for starting a audio and video application, performing audio and video operation and generating the audio and video information, and the transmitting terminal real-time monitoring processor being specifically used for encrypting the audio and video information using the fingerprint information of the instant communication transmitting terminal to obtain the encrypted audio and video information.

9. The system according to claim 8, wherein the transmitting terminal real-time monitoring processor comprises:
a first real-time monitoring sub-processor electrically coupled to the audio and video information generator, which is used for encrypting the whole audio and video information generated by the instant communication transmitting terminal by utilizing the fingerprint information of the instant communication transmitting terminal, to obtain the fully encrypted audio and video information of the instant communication transmitting terminal; or
a second real-time monitoring sub-processor electrically coupled to the audio and video information generator, which is used for encrypting a part of the audio and video information generated by the instant communication transmitting terminal by utilizing the fingerprint information of the instant communication transmitting terminal, to obtain the partially encrypted audio and video information of the instant communication transmitting terminal.

10. The system according to any one of claims 6-9, wherein the system further comprises an instant communication receiving terminal, which comprises:
a audio and video information receiver electrically coupled to the audio and video information transmitter, which is used for receiving the encrypted audio and video information from the audio and video information transmitter;
a receiving terminal fingerprint sensor electrically coupled to the audio and video information receiver, which is used for obtaining the fingerprint information of the instant communication transmitting terminal and performing identity authentication on the instant communication transmitting terminal by utilizing the fingerprint information of the instant communication transmitting terminal, after the audio and video information receiver receiving the encrypted audio and video information from the audio and video is information transmitter; and
a receiving terminal real-time monitoring processor electrically coupled to the receiving terminal fingerprint sensor, which is used for decrypting the encrypted audio and video information to obtain and display the audio and video information, after the receiving terminal fingerprint sensor accomplishing successful authentication of the instant communication transmitting terminal.
